(19) United States
(12) Patent Application Publication
(10) Pub. No.: US 2017/0269812 A1
(43) Pub. Date: Sep. 21, 2017

(54) DISPLAYING METHOD AND ELECTRONIC APPARATUS

(71) Applicant: MediaTek Singapore Pte. Ltd., Singapore (SG)

(72) Inventors: Dan Luo, Shaoshan (CN); Yi-Kai Lee, New Taipei City (TW); Xiaomeng Yan, Tianjin City (CN); Chun-Chia Chen, Hsinchu City (TW)

(21) Appl. No.: 15/462,909

(22) Filed: Mar. 19, 2017

(30) Foreign Application Priority Data
Mar. 21, 2016 (CN) 201610160627.2

(51) Int. Cl. G06F 3/0488; G09G 5/32; G06F 3/0483

(52) U.S. Cl. CPC G06F 3/0488; G06F 3/0483; G09G 5/32; G06F 2203/04803

(57) ABSTRACT

The present invention provides displaying methods and related electronic apparatus for displaying contents without being blocked by at least an object on a screen of the electronic apparatus. The electronic apparatus comprises: a blocking object determining circuit, a blocked area identifying circuit, a blocked contents identifying circuit, a blocked contents analyzing circuit, a screen contents display processor, and the screen. The present invention can make the blocked contents in the screen bypass the blocked area to be displayed while the users do not need to move their hands or other blocking objects.

### BACKGROUND

As for mobile device, its screen size tends to be increased and frameless with the display technology development. When users use a large screen or a frameless screen, some display areas of the screen might be blocked by some body parts (such as a hand) or other objects. The users have to move their hands or other blocking objects away to see the contents blocked by the hand or the other blocking objects when the users operating the conventional mobile devices.

### SUMMARY

According to a first aspect of the present invention, an exemplary displaying method for an electronic apparatus is disclosed. The exemplary displaying method comprises: determining whether an object on a screen of the electronic apparatus is a blocking object and generating a determining result; identifying a blocked area of the screen when the determining result shows that the object is the blocking object; identifying screen contents of the blocked area; analyzing a type of the screen contents; adjusting a display mode of the screen contents according to the type of the screen contents to bypass the blocked area; and displaying contents according to the adjusted display mode. In particular, the step of analyzing the type of the screen contents further comprises: determining whether an arrangement of the screen contents in the blocked area is changeable, or determining whether a zooming of the screen contents in the blocked area is changeable, or determining whether a shape change of the screen contents in the blocked area is changeable. In some embodiments, the method further comprises: detecting whether the contents are changed and generating a variation detecting result, wherein if the variation detecting result shows that the contents are changed, performing the identifying step to identify the screen contents of the blocked area.

According to a second aspect of the present invention, an exemplary electronic apparatus is disclosed. The exemplary electronic apparatus comprises: a blocking object determining circuit, for determining whether an object on a screen of the electronic apparatus is a blocking object and generating a determining result; a blocked area identifying circuit, coupled to the blocking object determining circuit, for identifying a blocked area of the screen when the determining result shows that the object is the blocking object; a blocked contents identifying circuit, coupled to the blocking area identifying circuit, for identifying screen contents of the blocked area; a blocked contents analyzing circuit, coupled to the blocking contents identifying circuit, for analyzing a type of the screen contents; a screen contents display processor, coupled to the blocked contents analyzing circuit, for adjusting a display mode of the screen contents according to the type of the screen contents to bypass the blocked area; and the screen, coupled to the screen contents display processor, for displaying contents according to the adjusted display mode. In particular, the blocked contents analyzing circuit determines whether an arrangement of the screen contents in the blocked area is changeable, or the blocked contents analyzing circuit determines whether a zooming of the screen contents in the blocked area is allowable, or the blocked contents analyzing circuit determines whether a shape change of the screen contents in the blocked area is allowable. In some embodiments, the electronic apparatus further comprises: a screen contents variation detecting circuit, coupled to the blocking contents identifying circuit and the screen, for detecting whether the contents are changed and generating a variation detecting result, wherein if the variation detecting result shows that the contents are changed, the screen contents variation detecting circuit transmits the contents to the blocking contents identifying circuit to perform the identifying process.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified block diagram of an electronic apparatus capable of displaying contents without being blocked by at least an object according to an embodiment of the present invention.

FIG. 2 is a simplified block diagram of the blocked area identifying circuit in FIG. 1 according to an embodiment of the present invention.

FIG. 3 is a simplified diagram of a user operating the electronic apparatus in FIG. 1 according to an embodiment of the present invention.

FIG. 4 is a simplified diagram of a user operating the electronic apparatus in FIG. 1 according to an embodiment of the present invention.

FIG. 5 is a simplified diagram of a user operating the electronic apparatus in FIG. 1 according to an embodiment of the present invention.

FIG. 6 is a simplified diagram of a user operating the electronic apparatus in FIG. 1 according to an embodiment of the present invention.

FIG. 7 is a simplified diagram of a user operating the electronic apparatus in FIG. 1 according to an embodiment of the present invention.

FIG. 8 is a flowchart showing a displaying method in accordance an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

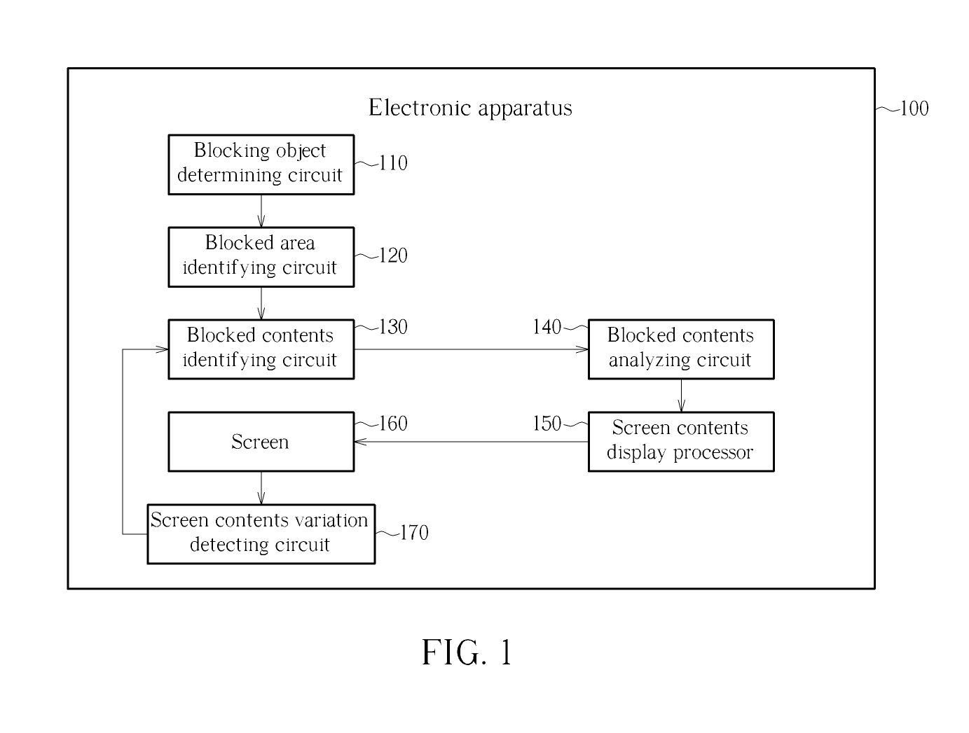

Please refer to FIG. 1. FIG. 1 is a simplified block diagram of an electronic apparatus 100 capable of displaying contents(s) without being blocked by at least an object according to an embodiment of the present invention. The electronic apparatus 100 can be a mobile device such a smartphone or a tablet computer. As shown in the embodiment of FIG. 1, the electronic apparatus 100 comprises: a blocking object determining circuit 110, a blocked area identifying circuit 120, a blocked contents identifying circuit 130, a blocked contents analyzing circuit 140, a screen contents display processor 150, a screen 160, and a screen contents variation detecting circuit 170.

The blocking object determining circuit 110 may determine whether an object on the screen 160 is a touching object (such as a user's finger for operating the electronic apparatus 100) or a blocking object (such as the user's palm or a part of the palm) and generate a determining result. Specifically, according to an embodiment, the blocking object determining circuit 110 may detect that whether a status of the screen 160 is a flatwise-laying status or a handheld status and generate a detecting result. When the detecting result shows that the status of the screen 160 is the flatwise-laying status, the blocking object determining circuit 110 further identifies an area of the object and determines whether the area is larger than an area threshold. If the area of the object is larger than the area threshold, the blocking object determining circuit 110 determines that the object is the blocking object. If the area of the object is not larger than the area threshold, the blocking object determining circuit 110 determines that the object is the touching object.

When the detecting result shows that the status of the screen 160 is the handheld status, the blocking object determining circuit 110 identifies at least an edge of the screen 160 and determines whether the object is near the at least an edge of the screen 160. If the object is near the edge of the screen 160, the blocking object determining circuit 110 determines whether duration of contacting time between the object and the screen 160 is greater than a time threshold. If the duration is greater than the time threshold, the blocking object determining circuit 110 determines the object is the blocking object. If the duration is not greater than the time threshold, the blocking object determining circuit 110 determines the object is the touching object. In addition, if the object is not near the edge of the screen, the blocking object determining circuit 110 further determines whether the area of the object is larger than an area threshold. If, the blocking object determining circuit 110 determines that the object is the blocking object if the area of the object is larger than the area threshold. Also, the blocking object determining circuit 110 determines that the object is the touching object if the area of the object is not larger than the area threshold.

In some embodiments, the area threshold may be a finger touching area, such as a half of a thumb area or a thumb area. The time threshold may be a long pressing time, such as 5 seconds, 8 seconds, or 10 seconds. This is only for an illustrative purpose and is not meant to be a limitation of the present invention. The above thresholds may be changed according to different designs, and may be predetermined by the system of the electronic apparatus 100 or set by the user. In addition, according to an embodiment, the blocking object determining circuit 110 may comprise an inertial sensor for detecting the status of the screen 160. This is only for an illustrative purpose and is not meant to be a limitation of the present invention. The blocking object determining circuit 110 may comprise other units to perform the detection.

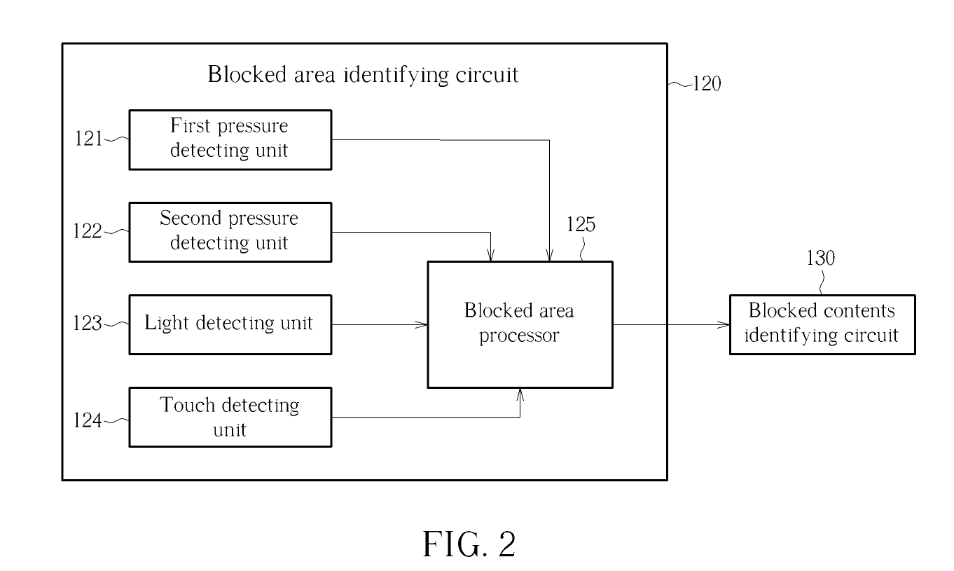

The blocked area identifying circuit 120 is coupled to the blocking object determining circuit 110, and utilized for identifying a blocked area of the screen 160 when the determining result shows that the object is the blocking object. Please refer to FIG. 2. FIG. 2 is a simplified block diagram of the blocked area identifying circuit 120 according to an embodiment of the present invention. As shown in FIG. 2, the blocked area identifying circuit 120 may comprise: a first pressure detecting unit 121, a second pressure detecting unit 122, a light detecting unit 123, a touch detecting unit 124, and a blocked area processor 125. The first detecting unit 121 may detect edge pressure of the screen 160 and generate at least an edge pressure signal. The second pressure detecting unit 122 may detect pressure from both front and back side of the screen 160, and generate at least a front and back pressure signal. The light detecting unit 123 may detect light of the screen 160 and generate at least a light signal. The touch detecting unit 124 may detect at least a touching point of the screen 160 and generate at least a touching signal. The blocked area processor 125 is coupled to the first detecting unit 121, the second detecting unit 122, the light detecting unit 123 and the touch detecting unit 124. The blocked area processor 125 may identify the blocked area of the screen 160 according to the edge pressure signal, the front and back pressure signal, the light signal, and/or the touching signal. After the identification, the block area processor 125 may inform the blocked contents identifying circuit 130 of the blocked area of the screen 160.

Please note that this is only for an illustrative purpose and is not meant to be a limitation of the present invention. The various detecting elements in the blocked area identifying circuit 120 may be changed according to different design requirements. According to an embodiment, the blocked area identifying circuit 120 may only comprise a first pressure detecting unit 121 and the blocked area processor 125. According to another embodiment, the first pressure detecting unit 121 and the second pressure detecting unit may be integrated in the same detecting unit.

The blocked contents identifying circuit 130 is coupled to the blocking area identifying circuit 120, and may perform an identifying process to identify screen contents of the blocked area. After the identification, the blocked contents identifying circuit 130 may inform the blocked contents analyzing circuit 140 of the screen contents of the blocked area. The blocked contents analyzing circuit 140 may analyze a type of the screen contents. Specifically, according to an embodiment, the blocked contents analyzing circuit 140 may determine whether an arrangement of the screen contents in the blocked area is changeable. In another embodiment, the blocked contents analyzing circuit 140 may determine whether a zooming of the screen contents in the blocked area is allowable. In yet another embodiment, the blocked contents analyzing circuit 140 may determine whether a shape change of the screen contents in the blocked area is allowable.

The screen contents display processor 150 is informed of the type of the screen contents by the blocked contents analyzing circuit 140. The screen contents display processor 150 may adjust a display mode of the screen contents according to the type of the screen contents to bypass the blocked area. The screen 160 is coupled to the screen contents display processor 150, and utilized for displaying contents according to the adjusted display mode. The screen contents variation detecting circuit 170 is coupled to the blocking contents identifying circuit 130 and the screen 160. It may detect whether the contents are changed and generate a variation detecting result. If the variation detecting result shows that the contents are changed, the screen contents variation detecting circuit 170 may transmit the contents to the blocking contents identifying circuit 130 for the identifying process. This is only for an illustrative purpose and is not meant to be a limitation of the present invention. The circuits/units in the electronic apparatus 100 may be altered according to different design requirements. For example, the screen contents variation detecting circuit 170 can be omitted in the electronic apparatus 100.

The blocked contents identifying circuit 130, the blocked contents analyzing circuit 140 and/or the screen contents display processor 150 may comprise at least one processor (e.g. one or more processors) arranged for running at least one program module (e.g. one or more program modules), and the program module(s) running on the aforementioned at least one processor may control operations of the electronic apparatus 100. According to some embodiments, at least one portion (e.g. a portion or all) of the blocked contents identifying circuit 130, the blocked contents analyzing circuit 140 and/or the screen contents display processor 150 may be implemented with a customized semiconductor chip such as an application-specific integrated circuit (ASIC).

According to different embodiments, when the blocked contents analyzing circuit 140 determines that the arrangement of the screen contents in the blocked area is changeable, the screen contents display processor 150 may change the arrangement of the screen contents to bypass the blocked area. When the blocked contents analyzing circuit 140 determines that the zooming of the screen contents in the blocked area is allowable, the screen contents display processor 150 may zoom the screen contents to bypass the blocked area. Alternatively, the screen contents display processor 150 may change shape of the screen contents to bypass the blocked area when the blocked contents analyzing circuit 140 determines that the shape change of the screen contents in the blocked area is allowable.

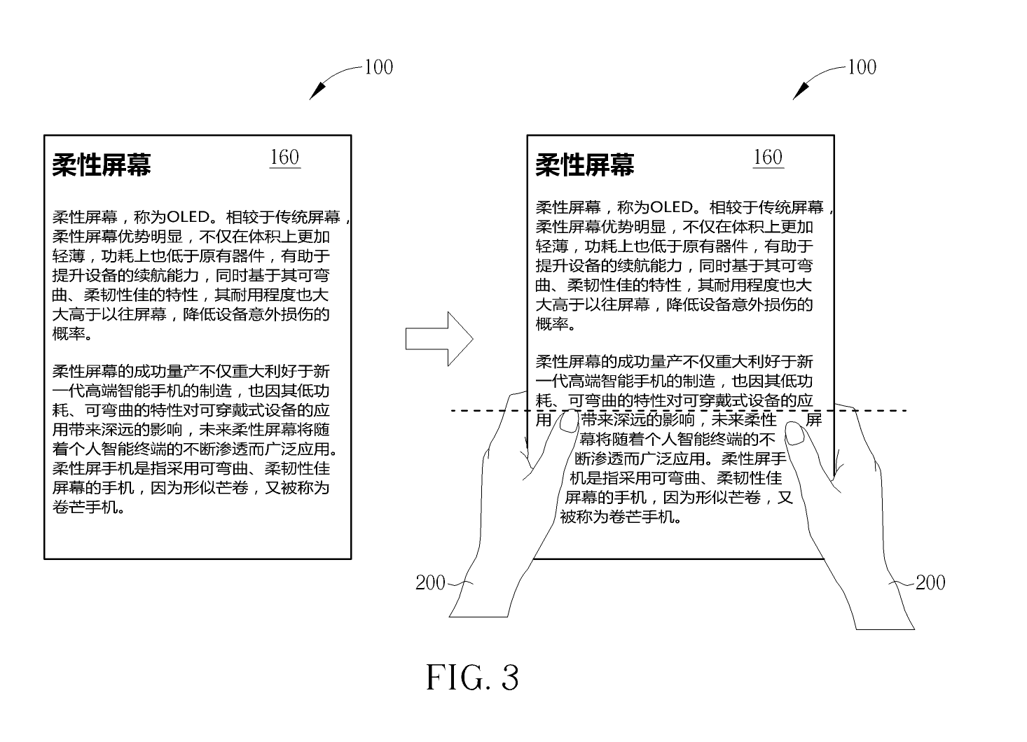

Please refer to FIG. 3. FIG. 3 is a simplified diagram of a user operating the electronic apparatus 100 according to an embodiment of the present invention. As shown in FIG. 3, when the blocking object determining circuit 110 determines that two hands 200 are blocking objects, the blocked area identifying circuit 120 may identify areas blocked by the two hands 200 of the user in the screen 160. The blocked contents identifying circuit 130 may perform an identifying process to identify screen contents of the areas blocked by the two hands 200 of the user. The blocked contents analyzing circuit 140 may analyze a type of the screen contents to determine that an arrangement of the screen contents in the areas blocked by the two hands 200 of the user is changeable. The screen contents display processor 150 may adjust the arrangement of the screen contents to bypass the areas blocked by the two hands 200 of the user if the arrangement of the screen contents is changeable. The screen 160 may display contents according to the adjusted display mode as shown in right side of FIG. 3.

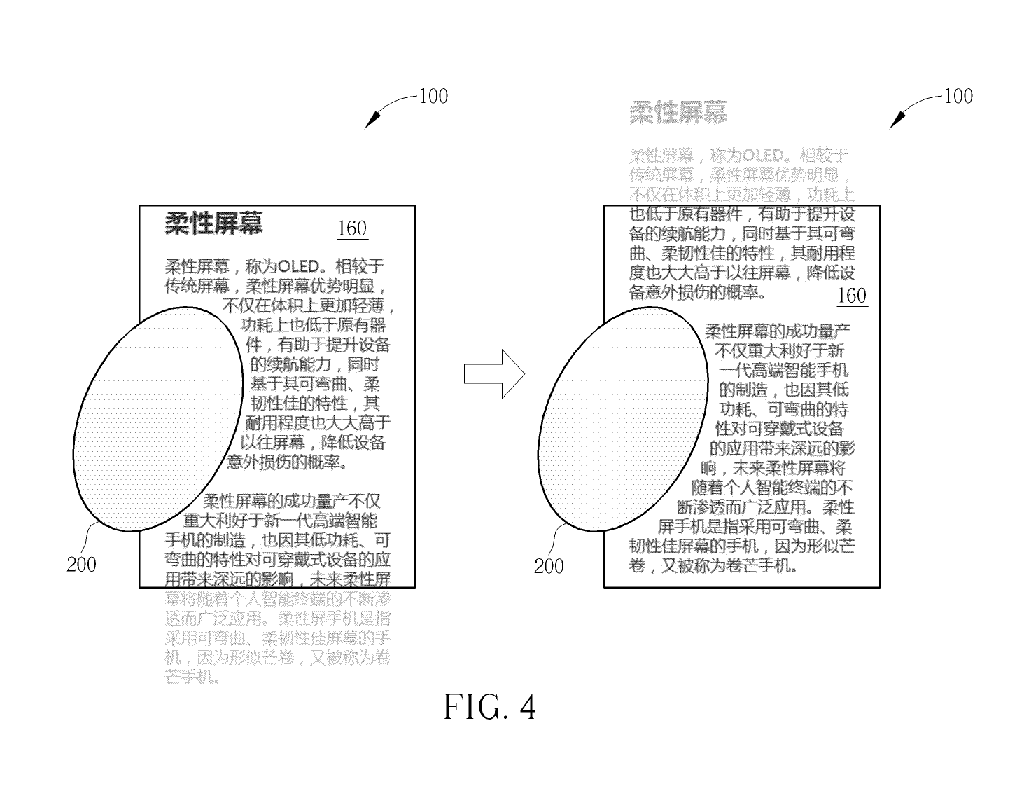

Please refer to FIG. 4. FIG. 4 is a simplified diagram of a user operating the electronic apparatus 100 according to another embodiment of the present invention. As shown in FIG. 4, screen contents are blocked by a hand 200. The screen contents variation detecting circuit 170 detects whether the contents are changed and generates a variation detecting result. If the variation detecting result shows that the contents are changed, the screen contents variation detecting circuit 170 transmits the contents to the blocking contents identifying circuit 130 to perform the identifying process, so as to make the screen contents display processor 150 be able to adjust the arrangement of the screen contents in real time. According to the embodiment in FIG. 4, as the screen contents are moving upward (i.e., the contents are changed), the screen contents display processor 150 may real-time adjust the arrangement to bypass the areas blocked by the hand 200 of the user, as shown in right side of FIG. 4. The screen contents variation detecting circuit 170 may comprise at least one processor (e.g. one or more processors) arranged for running at least one program module (e.g. one or more program modules), and the program module(s) running on the aforementioned at least one processor may control operations of the electronic apparatus 100.

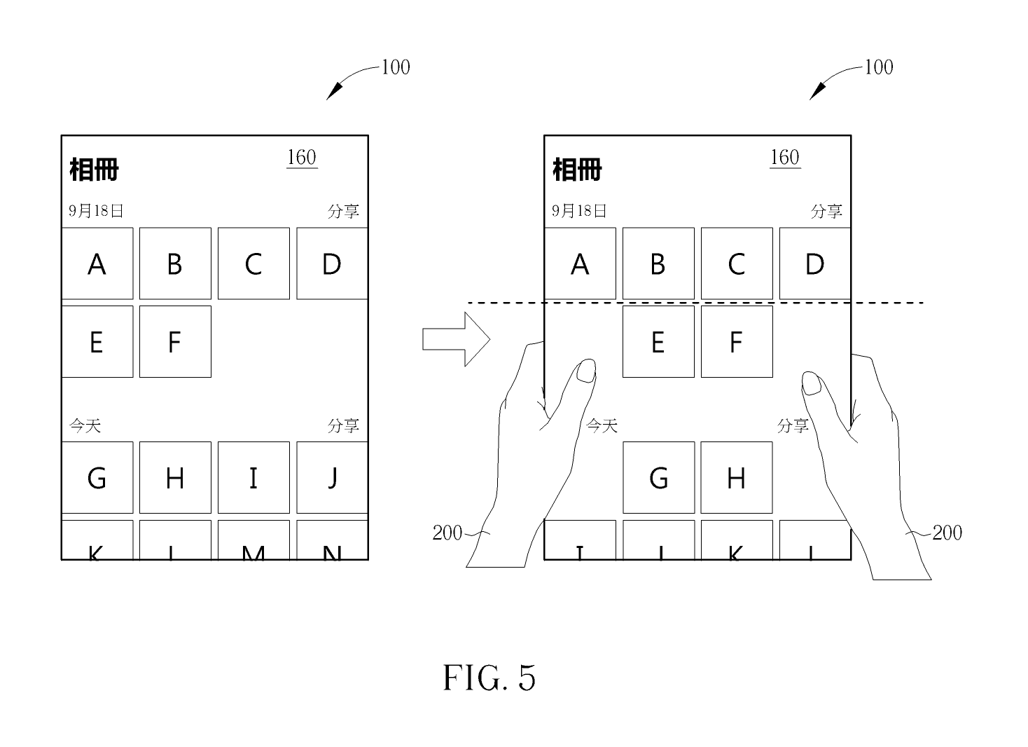

In addition, please note that although the contents are characters in the above embodiments, this is only for an illustrative purpose and is not meant to be a limitation of the present invention. For example, the present invention also works when the contents are block. FIG. 5 is a simplified diagram of a user operating the electronic apparatus 100 according to another embodiment of the present invention. As shown in FIG. 5, the screen contents display processor 150 may adjust an arrangement of the blocks to bypass the areas blocked by the two hands 200 of the user.

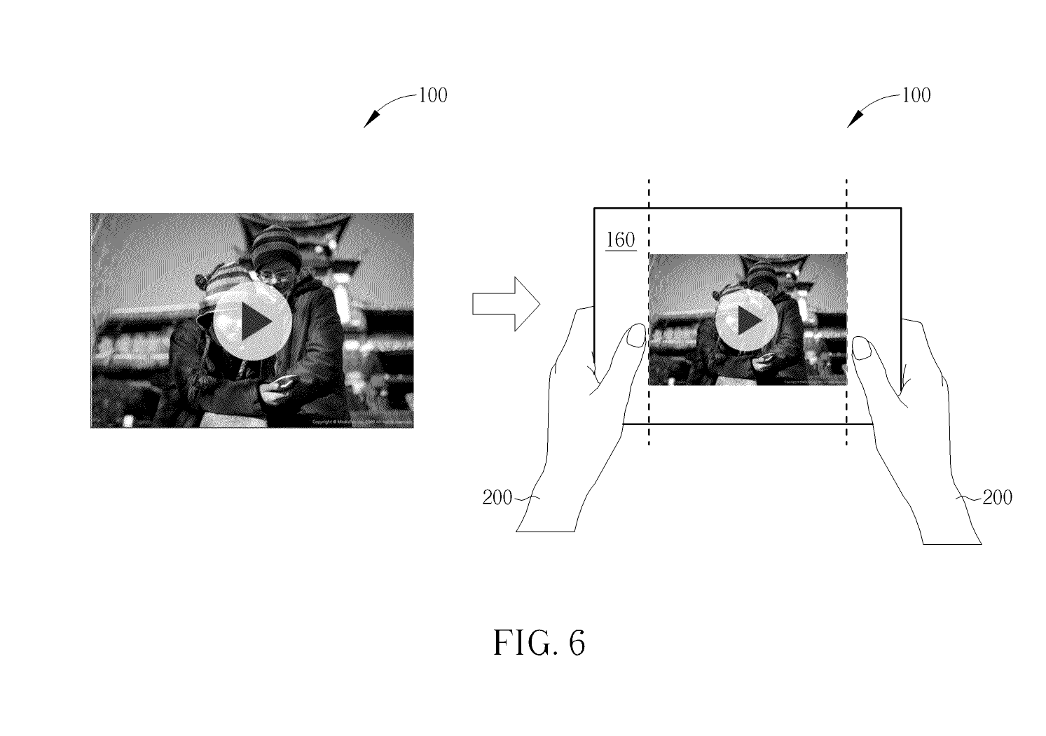

Please refer to FIG. 6. FIG. 6 is a simplified diagram of a user operating the electronic apparatus 100 according to another embodiment of the present invention. As shown in FIG. 6, when the blocking object determining circuit 110 determines that two hands 200 are blocking objects, the blocked area identifying circuit 120 may identify areas blocked by the two hands 200 of the user in the screen 160. The blocked contents identifying circuit 130 may perform an identifying process to identify screen contents of the areas blocked by the two hands 200 of the user. The blocked contents analyzing circuit 140 may analyze a type of the screen contents to determine that zooming of the screen contents in the areas blocked by the two hands 200 of the user is allowable. The screen contents display processor 150 is may zoom out the screen contents to bypass the areas blocked by the two hands 200 of the user. The screen 160 displays contents according to the adjusted display mode as shown in right side of FIG. 6.

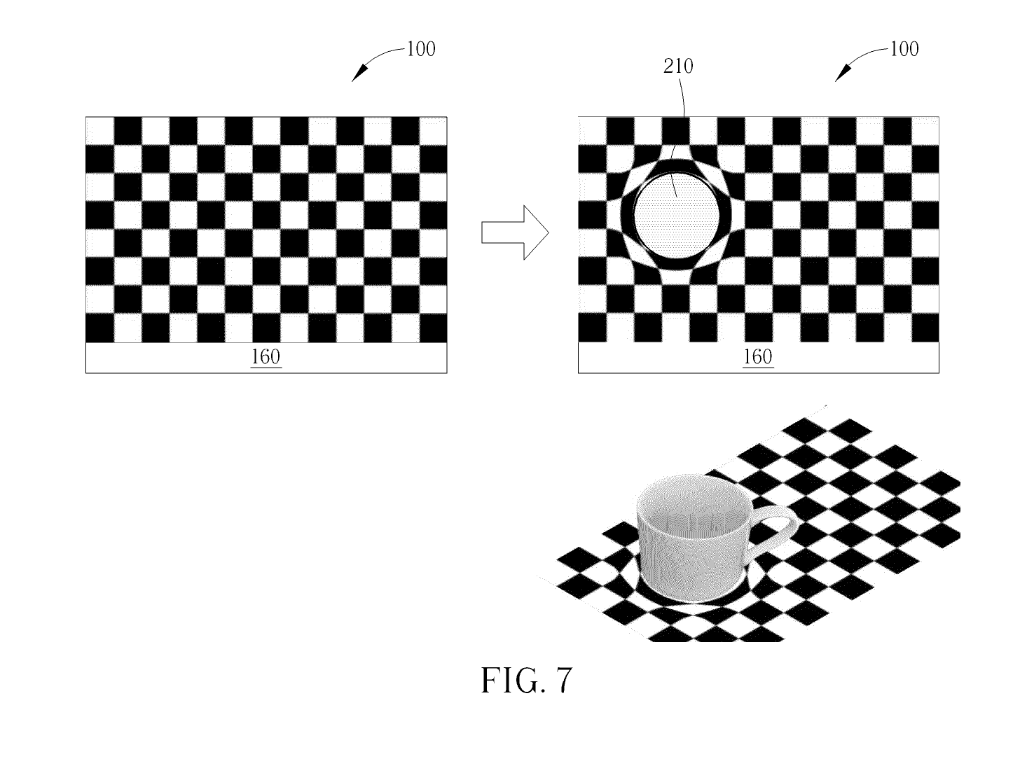

Please refer to FIG. 7. FIG. 7 is a simplified diagram of a user operating the electronic apparatus 100 according to another embodiment of the present invention. As shown in FIG. 7, when the blocking object determining circuit 110 determines that object 210 is a blocking object, the blocked area identifying circuit 120 may identify areas blocked by the object 210 in the screen 160. The blocked contents identifying circuit 130 may perform an identifying process to identify screen contents of the areas blocked by the object 210. The blocked contents analyzing circuit 140 may analyze a type of the screen contents to determine that the shape change of the screen contents in the areas blocked by the object 210 is allowable. The screen contents display processor 150 may change shape of the screen contents to bypass the areas blocked by the object 210. The screen 160 displays contents according to the adjusted display mode as shown in right side of FIG. 7.

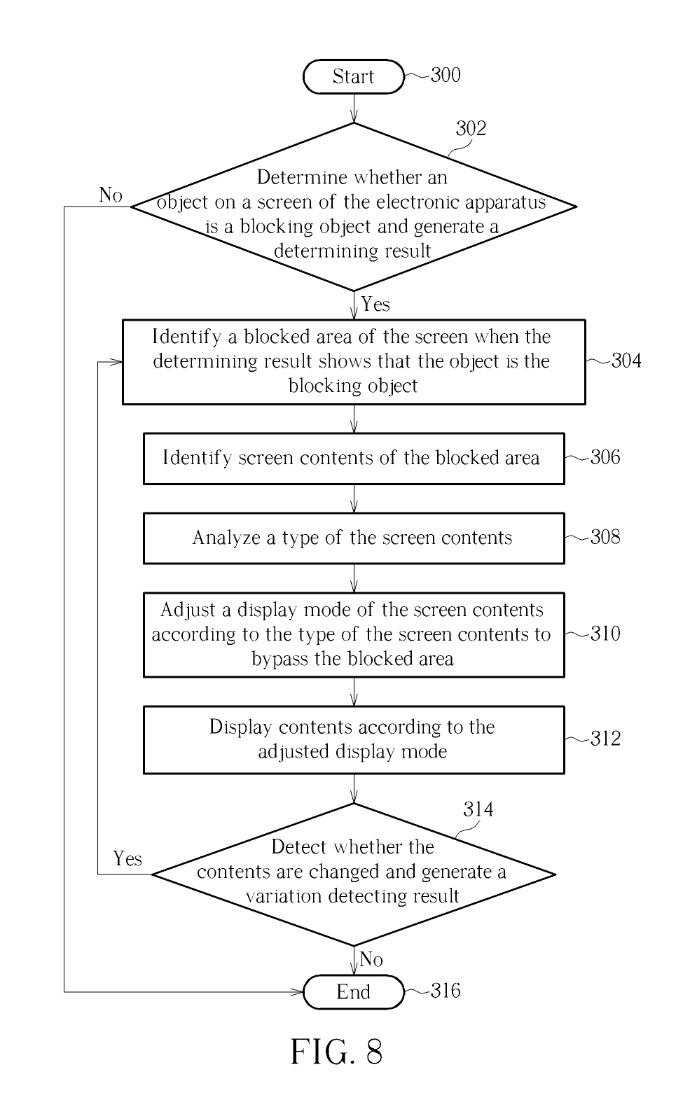

Please refer to FIG. 8. FIG. 8 is a flowchart showing a displaying method in accordance with an embodiment of the present invention. The displaying method can be applied to the electronic apparatus 100 for bypassing the blocking object to display the contents on the screen of the electronic apparatus. Provided that substantially the same result is achieved, the steps of the process flowchart do not have to be in the exact order shown in FIG. 8 and need not be contiguous, meaning that other steps can be intermediate or certain steps can be ignored. The method comprises the following steps:

Step 300: Start.

Step 302: Determine whether an object on a screen of the electronic apparatus is a blocking object and generate a determining result. If the determining result shows that the object is the blocking object, then go to Step 304. Otherwise, go to Step 316.

Step 304: Identify a blocked area of the screen when the determining result shows that the object is the blocking object.

Step 306: Identify screen contents of the blocked area.

Step 308: Analyze a type of the screen contents.

Step 310: Adjust a display mode of the screen contents according to the type of the screen contents to bypass the blocked area.

Step 312: Display contents according to the adjusted display mode.

Step 314: Detect whether the contents are changed and generate a variation detecting result. If the variation detecting result shows that the contents are changed, then go back to Step 306 again. Otherwise, go to Step 316.

Step 316: End.

Please note that the Step 314 can be omitted. In addition, the Step 302 may further comprise: detect whether a status of the screen is a flatwise-laying status or a handheld status and generate a detecting result. When the detecting result shows that the status of the screen is the flatwise-laying status, identify an area of the object and determine whether the area of the object is larger than an area threshold. The Step 314 may comprise determine the object is the blocking object if the area of the object is larger than the area threshold. When the detecting result shows that the status of the screen is the handheld status, identify at least an edge of the screen and determining whether the object is near the at least an edge of the screen. The Step 314 may comprise determine whether duration of contacting time between the object and the screen is greater than a time threshold if the object is near the edge of the screen. If the duration is greater than the time threshold, then determine the object is the blocking object. The Step 314 may comprise determine whether the area of the object is larger than the area threshold if the object is not near the edge of the screen. If the area of the object is larger than the area threshold, then determine the object is the blocking object.

In an embodiment of the present invention, the Step 308 may further comprise: determine whether an arrangement of the screen contents in the blocked area is changeable. When the arrangement of the screen contents in the blocked area is changeable, the step 310 may further comprise: change the arrangement of the screen contents to bypass the blocked area.

In another embodiment of the present invention, the Step 308 may further comprise: determine whether a zooming of the screen contents in the blocked area is allowable. When the zooming of the screen contents in the blocked area is allowable, the step 310 may further comprise: zoom the screen contents to bypass the blocked area.

In another embodiment of the present invention, the Step 308 may further comprise: determine whether a shape change of the screen contents in the blocked area is allowable. When the shape change of the screen contents in the blocked area is allowable, the step 310 may further comprise: change shape of the screen contents to bypass the blocked area.

Briefly summarized, the present invention can make the blocked contents in the screen bypass the blocked area to be displayed while the users do not need to move their hands or other blocking objects. The present invention can dynamically adjust the contents arrangement and display mode of the screen, in order to make the blocked contents intelligently bypass the blocked areas in the screen. The blocked contents can be characters, pictures, videos, and/or other kinds of contents. Re-arrangement of the contents can be varied with different kinds of the contents. Apparently, display methods of the invention are more user-friendly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A displaying method for an electronic apparatus, comprising:
determining whether an object on a screen of the electronic apparatus is a blocking object and generating a determining result;
identifying a blocked area of the screen when the determining result shows that the object is the blocking object;
identifying screen contents of the blocked area;
analyzing a type of the screen contents;
adjusting a display mode of the screen contents according to the type of the screen contents to bypass the blocked area; and
displaying contents according to the adjusted display mode.

2. The displaying method of claim 1, wherein the step of determining whether the object is the blocking object and generating the determining result further comprises:
detecting whether a status of the screen is a flatwise-laying status or a handheld status and generating a detecting result;
when the detecting result shows that the status of the screen is the flatwise-laying status, identifying an area of the object and determining whether the area of the object is larger than an area threshold; wherein if the area of the at least an object is larger than the area threshold, determining the object is the blocking object; and
when the detecting result shows that the status of the screen is the handheld status, identifying at least an edge of the screen and determining whether the object is near the at least an edge of the screen; wherein if the at least an object is near the at least an edge of the screen, determining whether duration of contacting time between the object and the screen is greater than a time threshold, and determining the object is the blocking object if the duration is greater than the time threshold; wherein if the object is not near the at least an edge of the screen, determining whether the area of the object is larger than the area threshold, and determining the object is the blocking object if the area of the object is larger than the area threshold.

3. The displaying method of claim 1, wherein the step of analyzing the type of the screen contents further comprises:
determining whether an arrangement of the screen contents in the blocked area is changeable.

4. The displaying method of claim 3, wherein when the arrangement of the screen contents in the blocked area is changeable, the step of adjusting the display mode of the screen contents according to the type of the screen contents to bypass the blocked area further comprises:
changing the arrangement of the screen contents to bypass the blocked area.

5. The displaying method of claim 1, wherein the step of analyzing the type of the screen contents further comprises:
determining whether a zooming of the screen contents in the blocked area is allowable.

6. The displaying method of claim 5, wherein when the zooming of the screen contents in the blocked area is allowable, the step of adjusting the display mode of the screen contents according to the type of the screen contents to bypass the blocked area further comprises:
zooming the screen contents to bypass the blocked area.

7. The displaying method of claim 1, wherein the step of analyzing the type of the screen contents further comprises:
determining whether a shape change of the screen contents in the blocked area is allowable.

8. The displaying method of claim 7, wherein when the shape change of the screen contents in the blocked area is allowable, the step of adjusting the display mode of the screen contents according to the type of the screen contents to bypass the blocked area further comprises:
changing shape of the screen contents to bypass the blocked area.

9. The displaying method of claim 1, further comprising:
detecting whether the contents are changed and generating a variation detecting result, wherein if the variation detecting result shows that the contents are changed, performing the identifying step to identify the screen contents of the blocked area.

10. An electronic apparatus, comprising:
a blocking object determining circuit, for determining whether an object on a screen of the electronic apparatus is a blocking object and generating a determining result;
a blocked area identifying circuit, coupled to the blocking object determining circuit, for identifying a blocked area of the screen when the determining result shows that the object is the blocking object;
a blocked contents identifying circuit, coupled to the blocking area identifying circuit, for identifying screen contents of the blocked area;
a blocked contents analyzing circuit, coupled to the blocking contents identifying circuit, for analyzing a type of the screen contents;
a screen contents display processor, coupled to the blocked contents analyzing circuit, for adjusting a display mode of the screen contents according to the type of the screen contents to bypass the blocked area; and
the screen, coupled to the screen contents display processor, for displaying contents according to the adjusted display mode.

11. The electronic apparatus of claim 10, wherein the blocking object determining circuit detects whether a status of the screen is a flatwise-laying status or a handheld status and generates a detecting result,
wherein when the detecting result shows that the status of the screen is the flatwise-laying status, the blocking object determining circuit identifies an area of the object and determines whether the area of the object is larger than an area threshold; and if the area of the object is larger than the area threshold, the blocking object determining circuit determines the object is the blocking object;
wherein when the detecting result shows that the status of the screen is the handheld status, the blocking object determining circuit identifies at least an edge of the screen and determines whether the object is near the at least an edge of the screen; wherein if the object is near the at least an edge of the screen, the blocking object determining circuit determines whether duration of contacting time between the object and the screen is greater than a time threshold, and determines the object is the blocking object if the duration is greater than the time threshold; wherein if the object is not near the at least an edge of the screen, the blocking object determining circuit determines whether the area of the object is larger than the area threshold, and determines the object is the blocking object if the area of the object is larger than the area threshold.

12. The electronic apparatus of claim 10, wherein the blocked contents analyzing circuit determines whether an arrangement of the screen contents in the blocked area is changeable.

13. The electronic apparatus of claim 12, wherein the screen contents display processor changes the arrangement of the screen contents to bypass the blocked area when the arrangement of the screen contents in the blocked area is changeable.

14. The electronic apparatus of claim 10, wherein the blocked contents analyzing circuit determines whether a zooming of the screen contents in the blocked area is allowable.

15. The displaying method of claim 14, wherein the screen contents display processor zooms the screen contents to bypass the blocked area when the zooming of the screen contents in the blocked area is allowable.

16. The electronic apparatus of claim 10, wherein the blocked contents analyzing circuit determines whether a shape change of the screen contents in the blocked area is allowable.

17. The electronic apparatus of claim 16, wherein the screen contents display processor changes shape of the screen contents to bypass the blocked area when the shape change of the screen contents in the blocked area is allowable.

18. The electronic apparatus of claim 10, further comprising:
a screen contents variation detecting circuit, coupled to the blocking contents identifying circuit and the screen, for detecting whether the contents are changed and generating a variation detecting result, wherein if the variation detecting result shows that the contents are changed, the screen contents variation detecting circuit transmits the contents to the blocking contents identifying circuit to perform the identifying process.

19. The electronic apparatus of claim 10, wherein the blocked area identifying circuit further comprises:
a first pressure detecting unit, for detecting at least an edge pressure of the screen and generating at least an edge pressure signal, and/or a second pressure detecting unit, for detecting pressure from both front and back side of the screen and generating at least a front and back pressure signal, and/or a light detecting unit, for detecting light of the screen and generating at least a light signal, and/or a touch detecting unit, for detecting at least a touching point of the screen and generating at least a touching signal; and
a blocked area processor, coupled to the first pressure detecting unit, the second pressure detecting unit, the light detecting unit, the touch detecting unit, and/or the blocking contents identifying circuit, for identifying the blocked area of the screen according to the edge pressure signal, the front and back pressure signal, the light signal, and/or the touching signal.
